(19) United States
(12) Patent Application Publication
(10) Pub. No.: US 2010/0153624 A1
(43) Pub. Date: Jun. 17, 2010

(54) DATA MANAGING METHOD FOR NON-VOLATILE MEMORY AND NON-VOLATILE MEMORY DEVICE USING THE SAME

(75) Inventor: Wu-Chi Kuo, Kaohsiung City (TW)

Correspondence Address: Wang Law Firm, Inc., 4989 Peachtree Parkway,, Suite 200, Norcross, GA, 30092, US

(73) Assignee: Silicon Motion, Inc., Jhubei City (TW)

(21) Appl. No.: 12/390,428

(22) Filed: Feb. 21, 2009

(30) Foreign Application Priority Data
Dec. 12, 2008 (TW) 97148497

(51) Int. Cl. G06F 12/02

(52) U.S. Cl. 711/103; 711/E12.008

(57) ABSTRACT

A data managing method for non-volatile memory which comprises a step for receiving a first logical block address and updated data, and a step for merging data in a plurality of physical blocks which have lowest usage rates according to usage parameters in a reference table when the first logical address doesn't exist in the reference table in a buffer memory and a number of pair blocks reaches a determined number.

### CROSS REFERENCE TO RELATED APPLICATIONS

This Application claims priority of Taiwan Patent Application No. 097148497, filed on Dec. 12, 2008, the entirety of which is incorporated by reference herein.

### BACKGROUND OF THE INVENTION

1. Field of the Invention

The present invention relates to non-volatile memory, and in particular relates to data managing method for the non-volatile memory.

2. Description of the Related Art

Flash memory is a kind of non-volatile memory which has developed rapidly in the recent years. The flash memory is usually applied in many portable storage apparatus such as SmartMedia cards, CompactFlash cards and PCMCIA ATA cards.

FIG. 1 is a schematic diagram of a flash memory apparatus in the prior art. The flash memory apparatus 100 comprises a flash memory 110 and a controller 120, wherein the controller 120 is used for controlling data transmission between the flash memory 110 and a host 130. The flash memory 110 is a non-volatile memory and the data stored therein will not disappear when the power is turned off. However, to improve the accessing efficiency between the flash memory 110 and the host 130, the controller 120 usually disposes of the buffer memory 122. The buffer memory 122, for example, could be a volatile memory such as synchronous dynamic random access memory (SDRAM). As long as the SDRAM can improve accessing efficiency, it is unnecessary to dispose of too much SDRAM in the buffer due to SDRAM's relatively high cost.

The flash memory 110 has several features that are (1) using a page, which is equal to 2K bytes, as a minimum unit to be read or written; while (2) using a block, which is equal to about 64 pages (about 128K bytes), as a minimum unit to be erased. Based on those limitations, one should consider its effect when operating the flash memory 110.

The flash memory 110 comprises a plurality of mother blocks 1a˜6a for storing the data received from the host 130. If the host 130 needs to transmit new data A′ to the flash memory 110 to replace the old data A stored in the mother block 1a (the new data A′ and the old data A should be all corresponding to the same logical block address, which is prior art and will not be discussed here), a new child block 1b in the spare blocks of the flash memory 110 will be selected to be stored the new data A′ in (given that the mother block 1a and the child block 1b are corresponding to each other, and the combination thereof is referred as a logical block 1). Similarly, the child blocks 2b˜6b would be generated when updating the other mother blocks 2a˜6a. Data in the same logical block will merge to release new space at the proper time, and which is prior art and will be discussed here.

FIGS. 2A, 2B and 2C are diagrams illustrating reference tables in the buffer memory buffer memory 122. The buffer memory 122 of the controller 120 comprises reference tables 1′˜5′ corresponding to the logical blocks 1˜5 respectively, and the reference tables 1′˜5′ further comprises correlative data of the mother blocks 1a˜5a and the child blocks 1b˜5b including, for example, physical block address, logical block address, etc. However, since the capacity of the buffer memory 122 is limited, when the capacity is fully occupied with data and the host 130 needs to access the logical block 6 of the flash memory 110, the buffer memory 122 has to release space to store the correlative information of the logical block 6 in the reference table 6′. Based on the first in first out (FIFO) principle of the prior art (assuming that the referenced tables 1′˜5′ are stored in the buffer memory 122 in order), the reference table 1′ of the buffer memory 122 will be erased, the logical block 1 of the flash memory 110 will merge, and the reference table 6′ will then be established, as shown in FIG. 2B. Meanwhile, if the host 130 needs to access the logical block 1 again, the reference table 2′ will be erased, the logical block 2 in the flash memory 110 will merge, and the reference table 1′ will be established in the buffer memory 122 according to the mentioned FIFO principle, as shown in FIG. 2C.

Repeatedly accessing the flash memory 110 for data merging is time-consuming and may reduce the life of the blocks therein, the method of the prior art is clearly not ideal. In order to improve the accessing efficiency of the flash memory, it was necessary to invent a new method for data management.

### BRIEF SUMMARY OF INVENTION

A data managing method for non-volatile memory is provided, comprising receiving a first logical block address and updated data; and merging data in a plurality of physical blocks which have the lowest usage rates according to the usage parameters in a reference table when the first logical address doesn't exist in the reference table in a buffer memory and a number of pair blocks reaches a determined number.

A non-volatile storage apparatus is provided, comprising a non-volatile and a controller, wherein the non-volatile memory comprises a plurality of physical storage blocks; the controller is electrically coupled to the non-volatile memory used for receiving a first logical block address and updated data; wherein the controller further comprises a buffer used for storing the updated data and a reference table and merging data in a physical block having the lowest usage rate according to usage parameters recorded in the reference table, and when the first logical address does not exist in the reference table in the buffer and a number of pair blocks reaches a determined number.

Another data managing method for non-volatile memory is provided. This comprises receiving a first logical block address and updated data; and clean correlative information of a second logical block which has the lowest usage rates according to usage parameters in a reference table when the first logical address doesn't exist in the reference table in a buffer memory and a number of pair blocks reaches a determined number.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic diagram of a flash memory apparatus in the prior art;

FIGS. 2A, 2B and 2C are diagrams illustrating reference tables in the buffer memory;

FIGS. 3A and 3B are flow charts of the data managing method for the flash memory according to the present invention;

FIGS. 4A and 4B are schematic diagrams of the buffer memory according to the present invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

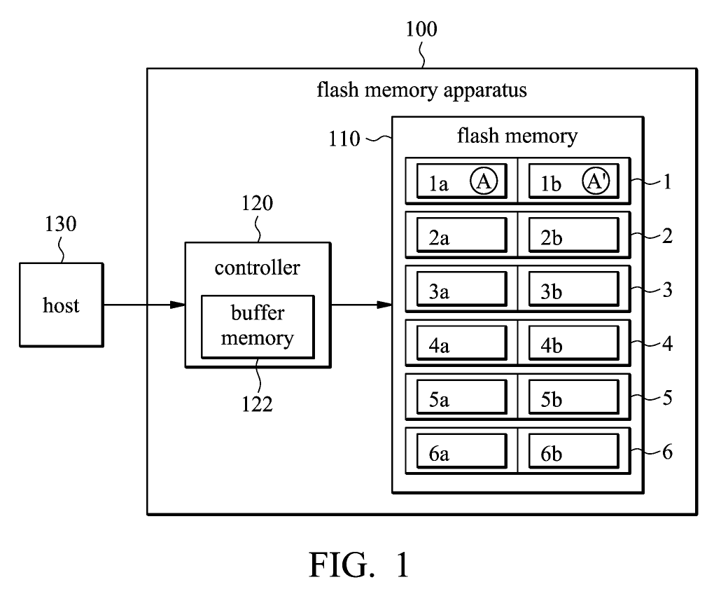

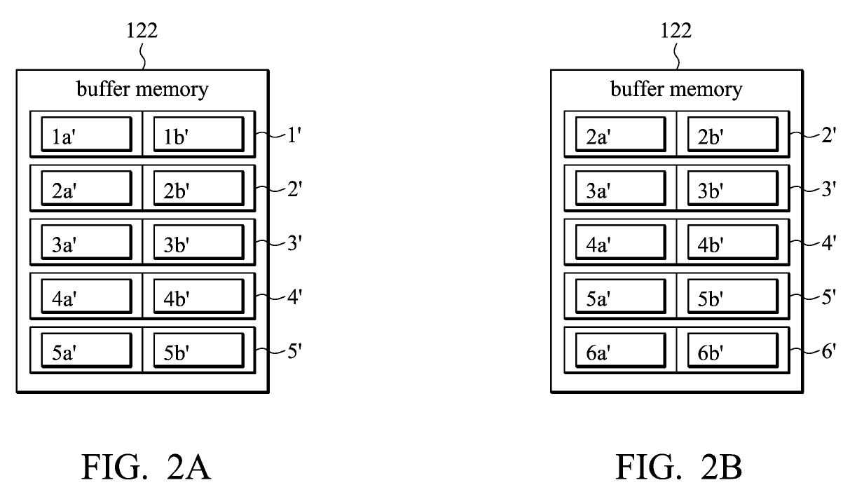

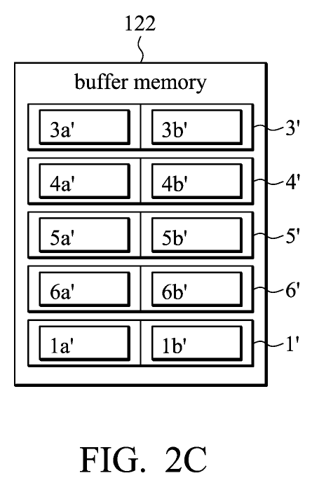

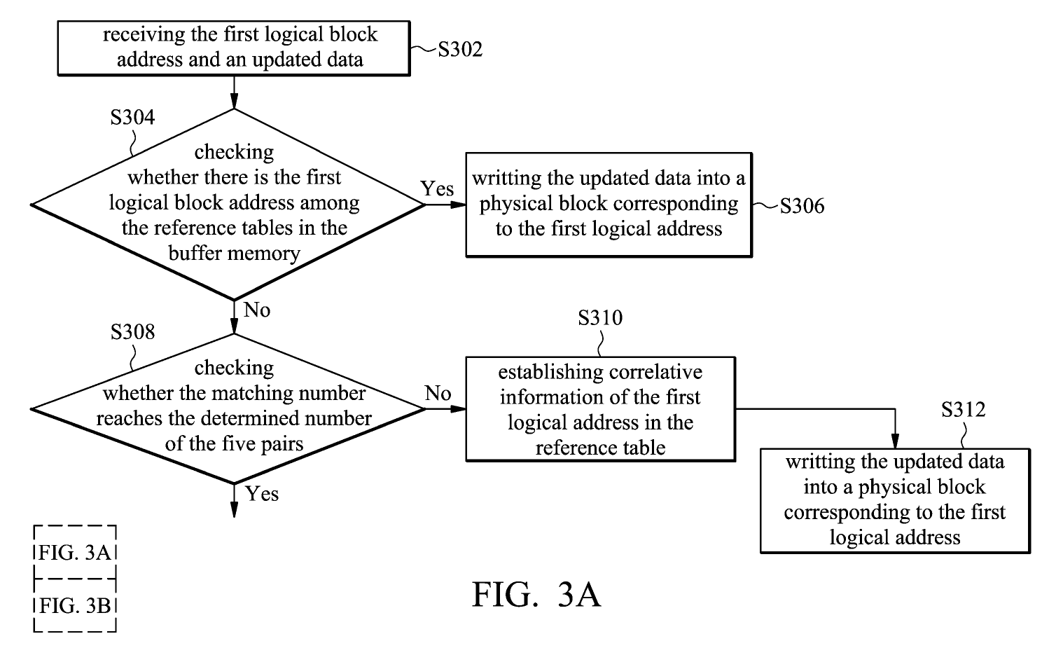

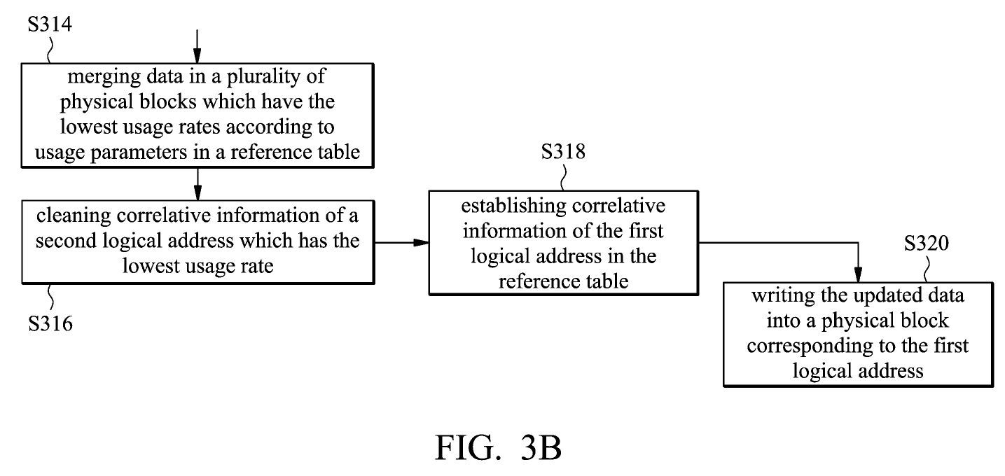

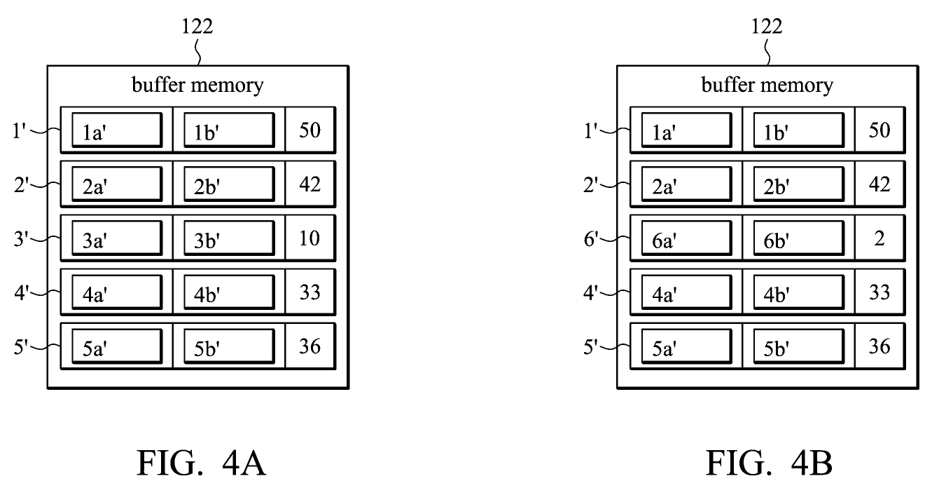

FIGS. 3A and 3B are flow charts of the data managing method for the flash memory according to the present invention, and FIG. 4A and FIG. 4B are schematic diagrams of the buffer memory 122 according to the present invention. The data managing method is performed by the controller 120 in the FIG. 1. Referring to FIGS. 1, 3, 4A and 4B, the flash memory apparatus 100 comprises the flash memory apparatus 100 and the controller 120, wherein the controller 120 controls the transmission between the flash memory 110 and the host 130 by using the present invention. The flash memory apparatus 100 has a plurality of logical blocks 1˜6 further including physical mother block 1a˜6a and physical child block 1b˜6b, while the buffer memory 122 has reference tables 1′˜5′ respectively corresponding to the logical blocks 1˜5. The reference tables 1′˜5′ have correlative information of the mother blocks 1a′˜5a′ and correlative information of the child blocks 1b′˜5b′ including, for example, physical block address, logical block address, etc. Moreover, the reference tables 1′˜5′ further contain usage parameters (for example, accessing times of each of the logical blocks). In this embodiment, the physical mother block 1a and physical child block 1b have the same logical block address and the accessing times whereof is 50; the physical mother block 2a and physical child block 2b have the same logical block address and the accessing times whereof is 42; the physical mother block 3a and physical child block 3 have the same logical block address and the accessing times whereof is 10; the physical mother block 4a and physical child block 4b have the same logical block address and the accessing times whereof is 33; and the physical mother block 5a and physical child block 5b have the same logical block address and the accessing times whereof is 36, as shown in FIG. 4A. Besides updated data, the storage capacity of the buffer memory 122, is set to store only five pairs of correlative information (reference tables 1′˜5′) in this embodiment, those skilled in the art will appreciate that the invention is not limited in this regard.

The data managing method for non-volatile memory according to the present invention comprises steps S302˜S318. In step S302, the flash memory apparatus 100 receives a logical block address and updated data for updating the data in the logical block 6 in the flash memory 110. In step S304, when the controller 120 catches an order from the host 130 to access the logical block 6 in the flash memory 110, the controller 120 checks whether there is a logical block address corresponding to the logical block 6 among the reference tables in the buffer memory 122. However, as shown in FIG. 4A, there is no correlative information of the logical block 6 in the reference tables. In step S308, the controller 120 further checks whether the number of pair blocks reaches the determined number of the five pairs. As shown in FIG. 4A, the number of pair blocks in the buffer memory 122 is five so that the buffer memory 122 has to release some space to store the correlative information of the logical block 6. In step S314, the controller 120 merges the logical block 3 of the flash memory 110 (including the physical mother block 3a and child block 3b). Next, in step S316, the controller 120 deletes/cleans the correlative information of the logical block 3 which has the lowest usage rate (accessing times is 10). In step S318, the controller 120 establishes correlative information of the reference table 6′ (which is corresponding to the logical block 6), wherein the correlative information comprises the physical block address of the mother block 6a and child block 6b and usage parameters thereof. Finally, in step S320, the controller 120 writes the updated data into the physical block 6b′ of the flash memory 110, meanwhile the usage parameter of the reference table 6 is 2.

In another embodiment, when the logical block address and updated data received by the flash memory apparatus 100 is corresponding to the logical block 1 of the flash memory 110, and the buffer memory 122 has already had the reference table 1′ corresponding to the logical block 1, the updated data will be written into the physical block 1b′ of the buffer memory 122 in step S306. Meanwhile, the usage parameters of the logical block 1 should be added 1 to be 51 (not shown).

Moreover, in the other embodiment, when the logical block address and updated data received by the flash memory apparatus 100 do not exist in the buffer memory 122, and the number of pair blocks of the buffer memory 122 (for example, 4 pairs) does not reach a determined number (5 pairs), the correlative information of the said logical block address will be established in the reference table in step S310, and the updated data will be written into the physical block corresponding to the said logical block address directly in step S312.

The data managing method according to the present invention is advantageous to the controller 120 to determine the usage of the logical blocks 1˜5. The logical blocks which are frequently accessed have a higher chance to be accessed again, and should be held in the buffer memory 122 when possible in order to reduce the time wasted in data-merging and extend the life of the flash memory 110. Otherwise, the logical blocks which are rarely accessed should be the first ones to merge. With the present invention, the data managing efficiency of the flash memory will be improved.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data managing method for non-volatile memory comprising:
receiving a first logical block address and updated data; and
merging data in a plurality of physical blocks which have the lowest usage rates according to usage parameters in a reference table when the first logical address doesn't exist in the reference table in a buffer memory and a number of pair blocks reaches a determined number.

2. The data managing method as claimed in claim 1 further comprises:
writing the updated data into a physical block corresponding to the first logical address when the first logical address exists in the in the reference table.

3. The data managing method as claimed in claim 1 further comprises:
establishing correlative information of the first logical address in the reference table when the first logical address does not exist in the buffer memory and the number of pair blocks does not reach the determined number.

4. The data managing method as claimed in claim 3, wherein the correlative information comprises at least the physical block address of a block and corresponding usage parameters of the logical block address.

5. The data managing method as claimed in claim 1 further comprises:
cleaning correlative information of a second logical address which has the lowest usage rate;
establishing correlative information of the first logical address in the reference table; and
writing the updated data into a physical block corresponding to the first logical address.

6. A non-volatile storage apparatus, comprising:
a non-volatile memory comprising a plurality of physical storage blocks;
a controller electrically coupled to the non-volatile memory used for receiving a first logical block address and an updated data,
wherein the controller further comprises a buffer used for storing the updated data and a reference table, and the controller merges data in a second logical block having the lowest usage rate according to usage parameters recorded in the reference table when the first logical address does not exist in the reference table in the buffer and a number of pair blocks reaches a determined number.

7. The non-volatile storage apparatus as claimed in claim 6, wherein the controller writes the updated data into the physical block corresponding to the first logical block address when the first logical block address exists in the buffer.

8. The non-volatile storage apparatus as claimed in claim 6, wherein the controller establishes correlative information of the first logical block address in the reference table when the first logical address does not exist in the buffer and the number of pair blocks does not reach the determined number.

9. The non-volatile storage apparatus as claimed in claim 8, wherein the correlative information comprises at least the physical block address of a block and corresponding usage parameters of the logical block address.

10. The non-volatile storage apparatus as claimed in claim 6, wherein the controller further erases correlative information from a second logical address which has the lowest usage rate, establishes correlative information of the first logical address in the reference table, and writes the updated data into a physical block corresponding to the first logical address.

11. A data managing method for non-volatile memory comprising:
receiving a first logical block address and updated data; and
erases correlative information from a second logical block which has the lowest usage rates according to usage parameters in a reference table when the first logical address doesn't exist in the reference table in a buffer memory and a number of pair blocks reaches a determined number.

12. The method as claimed in claim 11 further comprises:
writing the updated data into a physical block corresponding to the first logical address when the first logical address exists in the buffer memory.

13. The method as claimed in claim 11 further comprises:
establishing correlative information of the first logical address in the reference table when the first logical address does not exist in the buffer memory and the number of pair blocks does not reach the determined number.

14. The method as claimed in claim 13, wherein the correlative information comprises at least the physical block address of a block and corresponding usage parameters of the logical block address.

15. The method as claimed in claim further comprises:
merging data in the physical block which has the lowest usage rate;
establishing correlative information of the first logical address in the reference table; and
writing the updated data into a physical block corresponding to the first logical address.
